(19) United States
(12) Patent Application Publication
(10) Pub. No.: US 2008/0004153 A1
(43) Pub. Date: Jan. 3, 2008

(54) Diagnosis method and method and apparatus for optimizing the contact pressure security in a continuously variable transmission

(75) Inventor: Michael Reuschel, Ottersweier (DE)

Correspondence Address: ALFRED J MANGELS, 4729 CORNELL ROAD, CINCINNATI, OH, 452412433, US

(73) Assignee: LuK Lamellen und Kupplungsbau Beteiligungs HG, Buhl (DE)

(21) Appl. No.: 11/810,387

(22) Filed: Jun. 5, 2007

Related U.S. Application Data
(63) Continuation of application No. PCT/DE05/02111, filed on Nov. 24, 2005.

(30) Foreign Application Priority Data
Dec. 18, 2004 (DE) 10 2004 060 993.4

(51) Int. Cl. G01L 3/00; F16H 7/00

(52) U.S. Cl. 475/254; 73/862.31

(57) ABSTRACT

A method for diagnosing contact pressure security in a continuously variable transmission having conical disk pairs and a contacting endless belt. Contact pressure forces between the disks and the belt are modified at a given transmission ratio, at a defined input and/or output torque, and at a contact pressure having a defined zeta ratio value between the contact pressure force on the input disk set and on the output disk set. The input and/or output torque is held constant. The resulting change of transmission ratio is determined, and based upon the transmission ratio change the contact pressure security is assessed based upon the deviation between the existing pressure security and an optimum pressure security.

### CROSS-REFERENCE TO RELATED APPLICATION

This is a continuation of International Application Ser. No. PCT/DE2005/002111, with an international filing date of Nov. 24, 2005, and designating the United States, the entire contents of which is hereby incorporated by reference to the same extent as if fully rewritten.

### BACKGROUND OF THE INVENTION

1. Field of the Invention

The present invention relates to a method for diagnosing the contact pressure security in a continuously variable transmission. The invention also concerns a method and apparatus for optimizing the contact pressure security in such a transmission.

2. Description of the Related Art

FIG. 4 of the drawings shows a schematic diagram of a power train of a motor vehicle with a continuously variable transmission. An input shaft 6 driven by a drive engine (not shown) and interposed between a clutch and a rotational-direction-reversing transmission is fixedly connected to a conical disc 8 of an input-drive-side disc set SS1. An additional conical disc 10 is arranged nonrotatably and axially displaceably on the input shaft 6. Formed between a support component 11 fixedly connected to the input shaft 6 and the conical disc 10 are a pair of pressure chambers. The pressurization of those chambers facilitates the varying of the force that allows conical disc 10 to be pressed in the direction of conical disc 8.

In a similar manner, an output-side conical disc pair SS2 features a conical disc 14 fixedly connected to a driven or output shaft 12 and an axially moveable conical disc 16, which can be pressed in the direction of conical disc 14 through the pressurization of the connected pressure chambers. Running between the two disc sets SS1 and SS2 is a belt means 18, such as a chain, for example.

The contact pressure force with which the belt means 18 frictionally engages the conical surfaces of a conical disc set is controlled by means of hydraulic valves 20, 22, and 24, wherein the hydraulic valve 20 determines, in a known manner, a baseline pressure dependent upon a torque acting on the input shaft 6, and the transmission ratio is adjusted by means of the hydraulic valves 22 and 24.

Valves 20, 22, 24 are controlled by an electronic control unit 26, the inputs of which receive signals from sensors that contain essential information for controlling the valves. That information is then converted accordingly in the algorithms stored in the electronic control unit 26 into control signals for the valves. Further outputs of the electronic control unit 26 can control an automatic clutch, for example. The hydraulic valves 22 and 24 for adjusting the transmission ratio are not mandatory. It is advantageous if the electronic control unit 26 communicates via a bus line 28 with additional control units or other electronic devices of the motor vehicle. Because the construction and function of the arrangement illustrated in FIG. 4 are known, its features are not described.

To facilitate a lasting, reliable operation of a continuously variable transmission having a continuously adjustable transmission ratio, a suitable contact pressure between the belt means and the conical discs is imperative. By suitable, it is meant that the contact pressure on one hand ensures that the belt means does not slip, and on the other hand is not unnecessarily high, so that components are not subjected to undue stress, and efficiency is not compromised as a result of having to supply high levels of hydraulic pressure.

An object of the present invention is to provide a method and apparatus for ensuring a suitable contact pressure.

### SUMMARY OF THE INVENTION

A first solution for achieving the object is a method for diagnosing the contact pressure security in a continuously variable transmission, by which method at a defined transmission ratio of the transmission, a defined input and/or output torque, and a contact pressure with a defined ratio zeta between the contact pressure of the driving disk set and the contact pressure of the driven disk set, the contact pressure forces and zeta are changed while maintaining at least substantially constant the input and/or output torque, with which the resulting transmission ratio change is determined, and from the determined transmission ratio change a deviation between the existing and an optimal contact pressure security is completed.

Another solution for achieving the object is a method for optimizing the contact pressure security in a continuously variable transmission, by which method at a defined transmission ratio of the transmission, a defined input and/or output torque, and a contact pressure with a defined ratio zeta between the contact pressure of the driving disk set and the contact pressure of the driven disk set, the contact pressure forces and zeta are changed while maintaining at least substantially constant the input and/or output torque, with which the resulting transmission ratio change is determined and from the direction of the resulting change in transmission ratio the direction is determined in which the contact pressure for optimizing contact pressure security must be changed.

It is advantageous if the input torque to the transmission is kept at least substantially constant, the contact pressure forces are increased with zeta being held at least substantially constant and the contact pressure is increased during a UD-adjustment of the transmission ratio.

Furthermore, it is preferable if the optimization process is performed in such a way that the input torque to the transmission is kept at least substantially constant, the contact pressure forces are increased with zeta being held at least substantially constant, and the contact pressure is decreased during an OD-adjustment of the transmission ratio, and if the above-mentioned optimization process is repeated immediately thereafter.

In the present description, maintaining a substantial constant is understood as a state in which the parameters concerned show only minor deviations from a median value, for example +5 Nm from 100 Nm, or a deviation of +5% from a median value. While maintaining a constant in a strict mathematical sense is sought, it is not required.

It is advantageous if the change in contact pressure forces in relation to duration and amplitude with zeta being held substantially constant, is realized in such a way that a resulting transmission ratio change leads to a degree of comfort decrease below a threshold value (change in engine rotational speed or velocity) in a motor vehicle equipped with the transmission.

An apparatus for optimizing the contact pressure security in a continuously variable transmission contains a continuously variable transmission, a device for adjusting the contact pressure forces exerted by the conical disc pairs of the continuously variable transmission on the belt means, a device for adjusting the transmission ratio of the transmission, a device for adjusting at least one input torque of the belt means, a device for ascertaining the transmission ratio of the transmission, and a control device that is connected to those devices and that serves to execute the method described above.

### BRIEF DESCRIPTION OF THE DRAWINGS

The invention is explained in further detail with the aid of the attached schematic drawings.

The drawing figures show the following:

FIG. 1 curves for explaining a method for determining a zetamax-point;

FIG. 2 curves for explaining a modified method for determining the zetamax-point;

FIG. 3 curves for explaining the present invention; and

FIG. 4 the already described known design of a continuously variable transmission with elements for the control thereof.

### DESCRIPTION OF THE REFERRED EMBODIMENTS

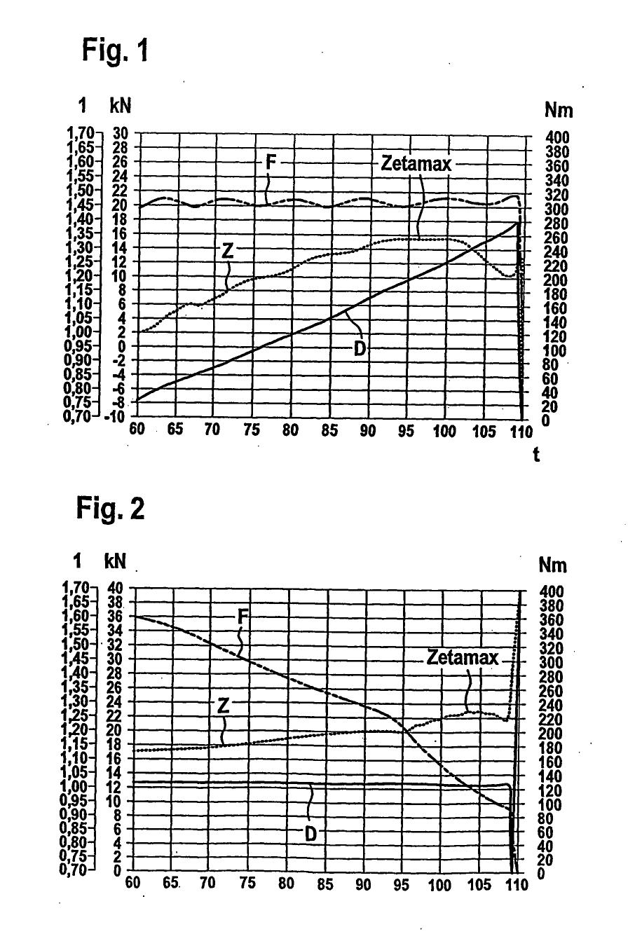

In FIG. 1, the curve F represents contact pressure force F in kN, with which the discs 14 and 16 of the driven disc set SS2 are pressed toward one another.

Curve D shows the torque in Nm that acts upon the driven disc set SS1 via the input shaft 6.

Z indicates the value of a parameter zeta=FSS1/FSS2.

The abscissa provides a uniform time duration scale for all curves.

FIG. 1 illustrates the following process:

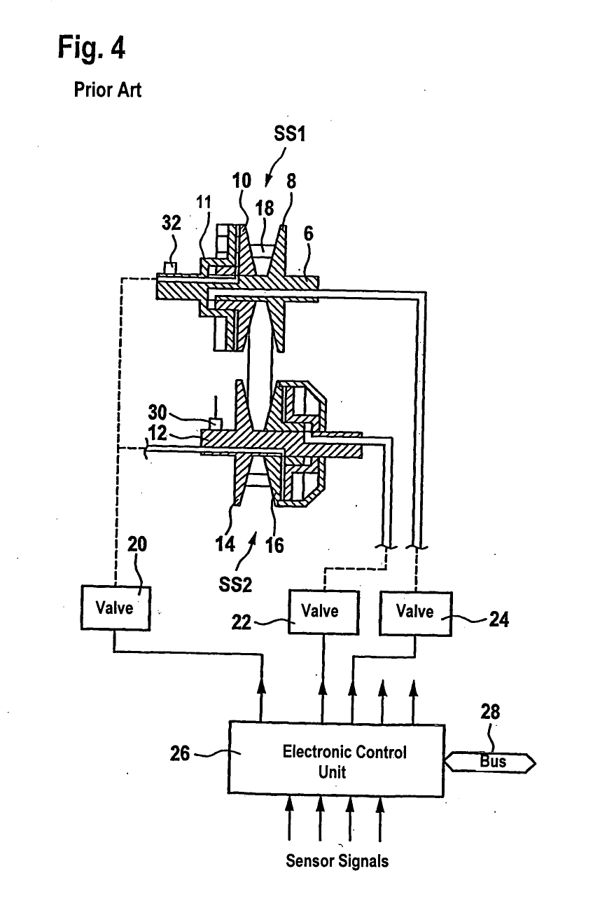

Starting from a defined contact pressure force F on the driven disc set SS2 (see FIG. 4), which securely ensures the transmission of starting torque, the input torque D is increased at a defined transmission ratio. A transmission ratio regulator integrated into electronic control unit 26 remains active and attempts to keep the transmission ratio constant despite the increase of torque D. If torque D increases with contact pressure force F on the driven disc set SS2 remaining the same, zeta (the ratio of the contact pressure force acting upon the disc set SS1 to the contact pressure force acting upon disc set SS2) initially increases. Starting at a certain level of torque, the rise of zeta slows down until a maximum value, zetamax, is reached. If torque D continues to climb, zeta falls until the transmission finally slips. The interval between the zetamax-point and the point of slippage ranges between 10 and 50% of the zetamax-value depending upon the transmission ratio.

Zeta is found to behave in a similar manner, when a process illustrated in FIG. 2 is initiated. In this figure, curve F again represents the contact pressure force on the driven disc set SS2. D represents the input shaft torque, while Z again represents the zeta value. In the process in accordance with FIG. 2, when torque is held constant, the contact pressure force F is minimized starting from a high excess contact pressure and a constant transmission ratio, while transmission ratio is perpetuated. As can be seen, the zeta value increases to a value zetamax, to then fall until the transmission slips due to an excessive drop in contact pressure force.

It has been shown that for a secure and reliable transmission of torque (slippage-free operation) when a not unnecessarily high contact pressure is present at the same time, the contact pressure force should be selected so that the system illustrated in FIGS. 1 and 2 is located to the left of and near the zetamax-point.

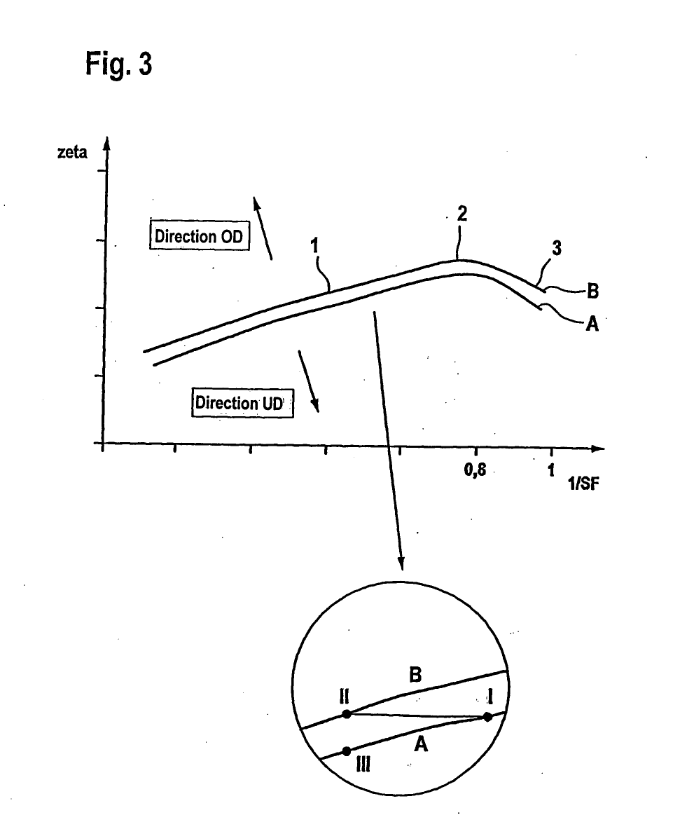

Based on that insight, the invention is further detailed below aided by FIG. 3.

In FIG. 3, the abscissa represents the inverse security factor (1/SF), which describes the ratio of the theoretically necessary contact pressure force—which is required for a suitable operation of the variable speed drive—to the contact pressure force actually present. A value of 1 indicates contact pressure nearing the slippage limit. For operation, an SF value of approximately 1.1 to 1.3 is targeted. The ordinate represents the zeta value.

Curves A and B are two examples from a set of curves and represent the course of the zeta value for two different constant transmission ratios of the transmission, where curve B corresponds to a longer transmission ratio than curve A, that is, a transmission ratio in the direction of overdrive. Such sets of zeta curves appear in similar form for each type of continuously variable transmission.

The Arabic numbers 1, 2, and 3 each refer to different regions, with 1 being a region to the left of the zetamax-point, which region is designated by 2, and 3 being a region to the right of the zetamax-point (each in accordance with FIG. 3).

The circular section is shown as an enlarged detail in FIG. 3 and clarifies the following process.

Starting from a stable state 1 on the zeta-curve A with given contact pressure, transmission ratio, input torque, and zeta-value, a defined jump in force on both of the disc sets is given at constant torque, or at least nearly constant torque. That is possible through the appropriate control of the valves as illustrated in FIG. 4. The respective level of jump in force on the input side disc set SS1 and the output side disc set SS2 is established in such a way that the zeta value does not change, that is, the following equation holds true:

$$Zeta = \frac{Fss 1}{Fss 2} = \frac{Fss 1 - Δ Fss 1}{Fss 2 - Δ Fss 2}$$

where F_{SS}₁ is the drive force acting on disc set SS1 before he jump in force, F_{SS2} is the drive force acting on disc set SS2 before the jump in force, and ΔF_{SS1} is the jump in force at disc set SS1, and ΔF_{SS2} is the jump in force at disc set SS2.

This relationship yields the following for a “zeta-compensated” jump in force:
ΔF_{SS1}=Zeta*ΔF_{SS2}

Such a zeta-compensated jump in force that operates in accordance with FIG. 3 causes the transmission state to move from state I to state II. In other words, the transmission ratio shifts in the direction of overdrive if Point I is to the left of the zetamax, or shifts in the direction of underdrive if Point I is sufficiently far to the right of zetamax. When the same contact pressure F and the same transmission ratio as in Point I are present, Point III can only be achieved at a reduced zeta-value, that is, it cannot appear on its own. The adjustment of transmission ratio (the transition from the zeta-curve A to the zeta-curve B) can be diagnosed directly through the output signals of the rotational speed sensors 30 and 32 (FIG. 4), which are connected to the electronic control unit 26, or through the diagnosis of the behavior of a transmission ratio regulator included in the electronic control unit 26.

The process illustrated with the aid of FIG. 3 can on one hand be used for diagnosing momentary contact pressure security if a compensated jump in force, as shown in FIG. 3, is initiated in a vehicle being driven in suitable operating state. It is understood that the jump in force can also be performed as a zeta-compensated lowering of the contact pressure forces, where the relationships of FIG. 3 are reversed in terms of direction. Contact pressure security is very high if a transmission ratio change occurs in the direction of OD (the system is in area region 1) during a compensated jump in force.

The process advantageously also lends itself to being used directly for optimizing the contact pressure security by increasing or decreasing the contact pressure following each reaction of the transmission ratio to a zeta-compensated jump in force.

The jump in force is advantageously carried out with regard to its amplitude and duration in such a way that it triggers only an adjustment of transmission ratio by a value that is not perceived by the vehicle occupants as adverse to comfort (such as sudden acceleration or deceleration).

It is also advantageous to perform a compensated jump in force for diagnosing or optimizing the contact pressure security only in a certain temperature range of the transmission, preferably in its normal operating temperature range. In that way, a good reproducibility of the characteristic values established for evaluation in the electronic control unit 26 is achieved.

It is also advantageous to perform a compensated jump in force only within a predetermined range of input torque or torque transmitted by the transmission, which in this example is clearly below the nominal torque of the transmission.

It is understood that the system for performing the described process illustrated in FIG. 4 is supplemented with additional sensors that are connected to the electronic control unit 26 and/or the necessary information, such as the pressure operative in the pressure chambers, torque acting upon the input shaft, etc. is fed to the electronic control unit via the bus line 28.

What is claimed is:

1. A method for diagnosing the contact pressure security in a continuously variable transmission that includes a driving conical disk set and a driven conical disk set, said method comprising the steps of:
changing contact pressure forces between the conical disks and a contacting belt means at a defined transmission ratio of the transmission, at at least one of a defined input and a defined output torque, and at a contact pressure with a defined ratio zeta between a contact pressure force of the driving disk set and a contact pressure force of the driven disk set while maintaining substantially constant the defined ratio zeta and at least one of the input torque and the output torque,
ascertaining a resulting change in transmission ratio, and
developing a deviation between a present contact pressure security and an optimal contact pressure security from the ascertained change in transmission ratio.

2. A method for optimizing the contact pressure security in a continuously adjustable transmission that includes a driving conical disk set and a driven conical disk set, said method comprising the steps of:
changing contact pressure forces between the conical disks and a contacting belt means at a defined transmission ratio of the transmission, at at least one of a defined input and a defined output torque, and at a contact pressure with a defined ratio zeta between a contact pressure force of the driving disk set and a contact pressure force of the driven disk set while maintaining substantially constant the defined ratio zeta and at least one of the input torque and the output torque,
ascertaining a resulting change in transmission ratio, and
determining from the direction of the resulting change in transmission ratio, the direction in which the contact pressure for optimizing contact pressure security must be changed.

3. A method in accordance with claim 2, including the steps of: maintaining the input torque of the transmission substantially constant, increasing the contact pressure forces with zeta being held substantially constant, and increasing the contact pressure during a UD-adjustment of the transmission ratio.

4. A method in accordance with claim 2, including the steps of: maintaining the input torque of the transmission substantially constant, increasing the contact pressure forces with zeta being held substantially constant, and increasing the contact pressure is increased during an OD-adjustment of the transmission ratio, and immediately thereafter repeating the process method steps claimed in claim 2.

5. A method as claimed in claim 2, including the step of holding the change in contact pressure forces in relation to duration and amplitude with zeta being held substantially constant in such a way that a resulting transmission ratio change leads to a change in engine rotational speed below a threshold value in a motor vehicle equipped with the transmission.

6. Apparatus for optimizing the contact pressure security in a continuously variable transmission, said apparatus comprising:
a continuously variable transmission including input and output conical disk pairs operatively interconnected by a belt means,
means for adjusting contact pressure forces exerted on the belt means (18) by the conical disk pairs (SS1, SS1) of the continuously variable transmission,
means for adjusting the transmission ratio of the transmission,
means for adjusting an input torque to the belt means,
means for ascertaining the transmission ratio of the transmission, and
a control unit operatively connected to these devices the adjusting means for executing the method as claimed in claim 2.
